(19) United States
(12) Patent Application Publication
(10) Pub. No.: US 2018/0134131 A1
(43) Pub. Date: May 17, 2018

(54) Arrangement for a winding system and winding system for a vehicle roof

(71) Applicant: WEBASTO SE, Stockdorf (DE)

(72) Inventors: Stephan KUGLER, Stockdorf (DE); Thomas SICHART, Stockdorf (DE)

(21) Appl. No.: 15/572,605

(22) PCT Filed: May 12, 2016
(86) PCT No.: PCT/EP2016/060723

§ 371 Date: Nov. 8, 2017

(30) Foreign Application Priority Data
May 13, 2015 (DE) 10 2015 107 573.3

(51) Int. Cl. B60J 7/00; B60J 1/20; B60J 7/08

(52) U.S. Cl. CPC B60J 7/0015; F16C 33/04; B60J 7/085; B60J 1/2033

(57) ABSTRACT

An arrangement for a winding system has a shaft, which is designed such that it can rotate about a longitudinal axis, and a bearing bush, which is arranged in a recess of the shaft and is coupled to the shaft. The arrangement also may comprises a bearing element, which is arranged at a distance from the bearing bush in the recess of the shaft. A sliding element is arranged between the bearing bush and the bearing element in the recess of the shaft. Furthermore, a drive element is arranged such that it can rotate about the longitudinal axis in the recess of the shaft and is coupled to the bearing bush. The drive element is designed to wind and/or unwind a flexible element by means of the shaft.

The present invention relates to an arrangement for a winding system and a winding system for a vehicle roof, which are suitable for in a simple manner enabling a flexible element to be reliably wound up and/or unwound.

Usually, by means of a winding system, for example, a flexible element is wound up and/or unwound in order, inter alia, to obscure or open up a roof window in a vehicle roof. In this case, the flexible element is frequently a roller blind or a roller blind system, in which a wind-up function is realized, for instance, by means of a shaft, torsion springs and bearing bushes. These components are usually rotatable about a longitudinal axis of the roller blind system.

On the part of the Applicant, at least company-internal arrangements are known, in which, upon rotation, a displacement or drifting of the bearing bushes can occur, since these are not reliably positioned in relation to the longitudinal axis. Such drifting of the bearing bushes has, inter alia, an adverse effect on the wind-up behavior of the roller blind or winding system. Furthermore, a lack of bracing of the mutually interacting components gives rise to a rattling potential, which makes an undesirable noise generation possible and thereby diminishes the worth of the winding system.

The object of the invention is therefore to provide an arrangement for a winding system and a winding system for a vehicle roof which are suitable for enabling a flexible element to be wound up and/or unwound in an improved manner.

The object is achieved by the features of the independent patent claims.

An arrangement according to the invention for a winding system comprises a shaft, which has a recess and a longitudinal axis about which it is rotatably configured, and a bearing bush, which has a contact surface and which is arranged rotatably about the longitudinal axis in the recess of the shaft and is coupled to the shaft. The arrangement further comprises a bearing element, which has a contact surface and which is arranged at a distance from the bearing bush in the recess of the shaft, and a sliding element, which has a first and a second contact surface and which is arranged between the bearing bush and the bearing element in the recess of the shaft. Moreover, the arrangement comprises a drive element, which is arranged rotatably about the rotational axis in the recess of the shaft and is coupled to the bearing bush and which is configured such as to wind up and/or unwind a flexible element by means of the shaft, wherein the drive element exerts a force on the bearing bush in the direction of the bearing element, so that the contact surface of the bearing bush and the first contact surface of the sliding element, as well as the second contact surface of the sliding element and the contact surface of the bearing element, make contact with each other.

In this way, an arrangement for a winding system, which arrangement enables the flexible element to be reliably wound up and/or unwound, is realized. For instance, the flexible element is a roller blind and the associated winding system is a roller blind system which, in particular by means of the shaft and the drive element, enables the roller blind to be wound up and/or unwound.

Because the drive element exerts a force on the bearing bush in the direction of the bearing element, the bearing bush, the sliding element and the bearing element are fixed substantially in their position relative to one another and in relation to the longitudinal axis. By means of the respective contact surfaces, the aforementioned components bear one against another and, during operation of the arrangement or of the associated winding system, the position of the interacting components along the longitudinal axis is also substantially maintained. The drive element thus realizes a reliable coupling between the bearing bush and the bearing element. In this way, inter alia a displacement of the bearing bush during a rotation is prevented, or at least opposed, and so an improved wind-up and/or unwinding behavior of the winding system is realized. Moreover, the described arrangement enables an improved running and an improved smoothness of running of the winding system in comparison to arrangements in which the described components are not braced one against another.

By means of bracing of the respective components, a robust design of the arrangement, which also reduces a rattling potential of the interacting components during operation of the arrangement, is additionally realized. A reduced rattling potential leads to a diminished noise generation and has an advantageous effect on the quality of the arrangement or of an associated winding system comprising such an arrangement.

In order that an abutment or bracing of the aforementioned components is possible also during operation of the arrangement, and that the bearing bush can rotate relative to the bearing element, the sliding element is arranged as an additional element between the bearing bush and the bearing element. The sliding element enables a substantially permanent coupling between the bearing bush and the bearing element, in particular during wind-up and/or unwinding of the flexible element.

The sliding element has, for example, material characteristics and surface properties which enable, on the one hand, a reliable rotation of the bearing bush and, on the other hand, a secure coupling between bearing bush and bearing element. In contrast to the shaft, to the bearing bush and to the drive element, for example, the sliding element and bearing element are non-rotatably arranged or configured and represent substantially stationary components with regard to an operation of the arrangement.

According to a refinement of the arrangement, the bearing bush has a recess, in which the sliding element is arranged.

For instance, the sliding element is arranged in the recess of the bearing bush such that it makes contact with a part of a wall of the bearing bush and is surrounded by the bearing bush like by a type of collar. The part of the wall realizes the contact surface of the bearing bush and is, for instance, in positive contact with the first contact surface of the sliding element.

Because the sliding element is arranged within the recess of the bearing bush, a compact arrangement for a winding system is realizable, which compact arrangement, moreover, enables the flexible element to be wound up and/or unwound in a reliable and quiet manner.

According to a refinement of the arrangement, the drive element is arranged between the bearing element and a wall of the shaft and exerts a tensile force on the bearing bush.

The drive element is realized, for example, as a helical spring and is arranged on a side of the bearing bush that is facing toward the sliding element. The helical spring is coupled, for instance, to the bearing bush and pulls the bearing bush in the direction of the bearing element. In this way, the bearing bush is braced against the sliding element, and the sliding element against the bearing element. Thus, an arrangement which in a simple manner enables a coupling of the bearing bush to the bearing element and fixes the position of the bearing bush with respect to the longitudinal axis is realizable.

Alternatively to the described refinement, the drive element is arranged in the recess of the shaft on a side of the bearing bush, for instance, that lies opposite to the sliding element, and said drive element exerts a compressive force on the bearing bush in the direction of the bearing element. The drive element then presses, for example, the bearing bush against the sliding element, and consequently the sliding element against the bearing element.

According to further refinement of the arrangement, the drive element has a spring arm, which is coupled to the bearing bush and by means of which a tensile force is exerted on the bearing bush.

This refinement of the arrangement defines a possible configuration of the drive element in which a coupling between drive element and bearing bush is realized by means of the spring arm. If the drive element is constructed, for instance, as a helical spring, then it realizes, on the one hand, a wind-up and/or unwinding of the flexible element by means of the shaft and, on the other hand, a tensile force on the bearing bush in the direction of the bearing element by means of the spring arm. The helical spring is in this case configured, for example, as a combined tension and torsion spring, and thus in a simple manner enables a bracing of the interacting components, and hence an improved winding behavior of the arrangement with diminished noise generation due to the reduced rattling potential.

The spring arm extends, for example, between the wall of the shaft and the bearing bush and engages at a predefined position a purposefully configured contour or recess of the bearing bush. The spring arm of the drive element thus realizes a positive or non-positive coupling to the bearing bush, and consequently a coupling of the bearing bush to the sliding element and the bearing element.

According to a refinement of the arrangement, the sliding element is of disk-shaped configuration.

The sliding element is realized, for instance, as a sliding disk and thus enables, for example, a rotationally symmetric configuration of the described arrangement for a winding system, which configuration is beneficial with regard to a wind-up or unwinding of the flexible element.

According to a refinement of the arrangement, the arrangement has a bearing journal, which is configured to couple the arrangement to a motor vehicle and which extends from outside the shaft into the recess of the bearing bush and the recess of the shaft.

This refinement of the arrangement constitutes a possibility of coupling to a motor vehicle. For instance, a winding system comprising a configuration of the arrangement is attached by means of the bearing journal to an inner side of a vehicle roof of the motor vehicle and thus enables a reliable obscurement or opening up of a roof window integrated in the vehicle roof.

With regard to a symmetrical configuration of the winding system, it is advantageous that at both ends of the shaft are respectively arranged a bearing journal, a bearing bush and a sliding element, which are respectively assigned to one end of the bearing element. The drive element can be configured, for example, as a single element which at both ends respectively has a spring arm, or else there are provided two drive elements, which realize a reliable coupling of the respective bearing bush to the bearing element. But more than one of the bearing element, too, can be present, so that, for instance, a bearing element is respectively assigned to one side of the winding system and an operable winding system comprises, for example, two of the described configurations of the arrangement.

According to a refinement of the arrangement, the sliding element and the bearing element respectively have a recess, and the bearing journal extends through the recess of the bearing bush and through the recess of the sliding element into the recess of the bearing element and couples to the latter.

The bearing journal has, for example, a pin-shaped structure, which extends through the recess of the bearing bush and of the sliding element into the recess of the bearing element. The pin-shaped structure of the bearing journal is pressed, for instance, into the recess of the bearing element and realizes a positive and/or non-positive coupling to the bearing element. Furthermore, still further alternative or additional possibilities for the coupling between bearing journal and bearing element also exist, so that a reliable and stable winding system is enabled.

A winding system according to the invention for a vehicle roof comprises one of the previously described arrangements and the vehicle roof of a motor vehicle. The characteristics and advantages described with regard to the arrangement apply also to the winding system comprising at least one arrangement.

Exemplary embodiments of the invention are explained in greater detail below on the basis of the schematic drawings, wherein:

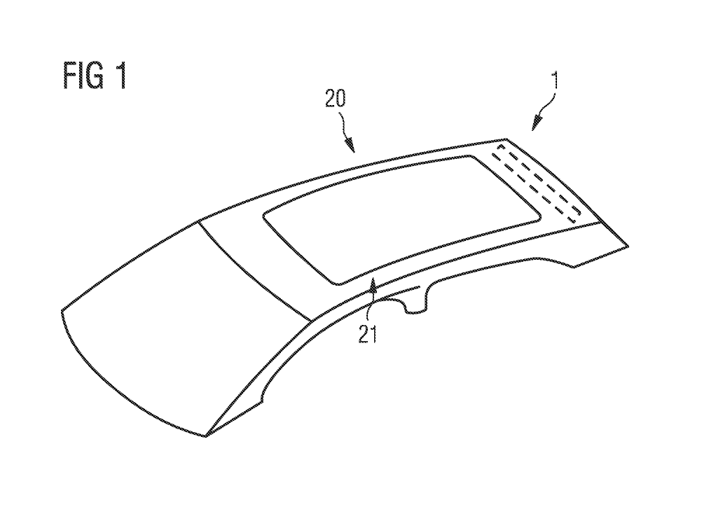

FIG. 1 shows an exemplary embodiment of a winding system for a vehicle roof,

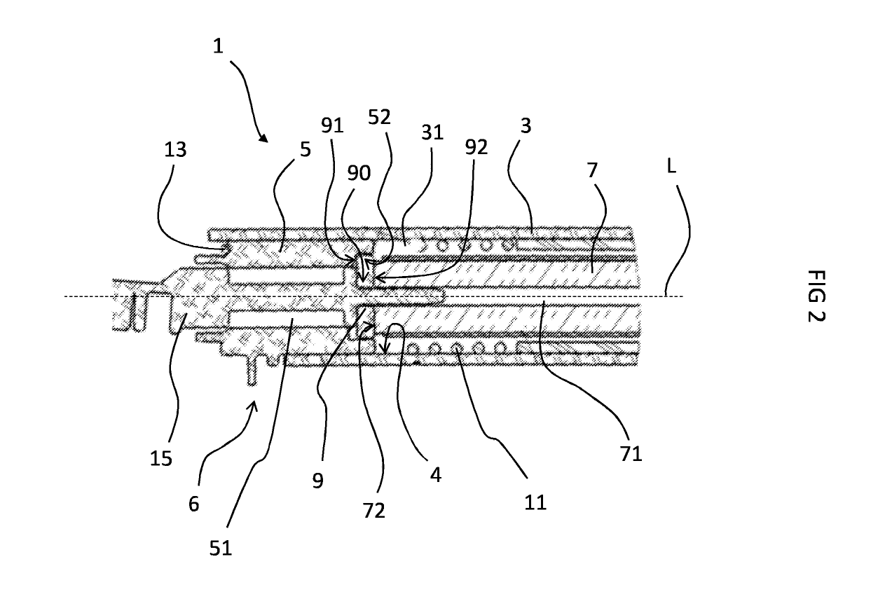

FIG. 2 shows an exemplary embodiment of an arrangement for a winding system,

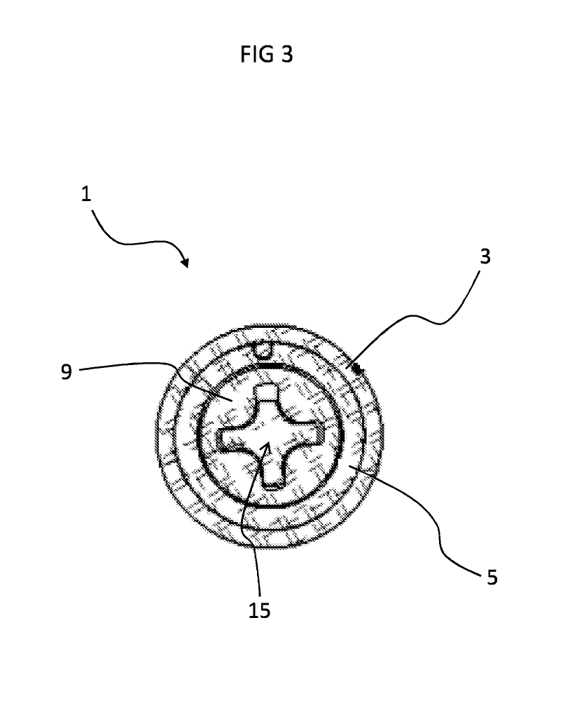

FIG. 3 shows a further exemplary embodiment of an arrangement for a winding system,

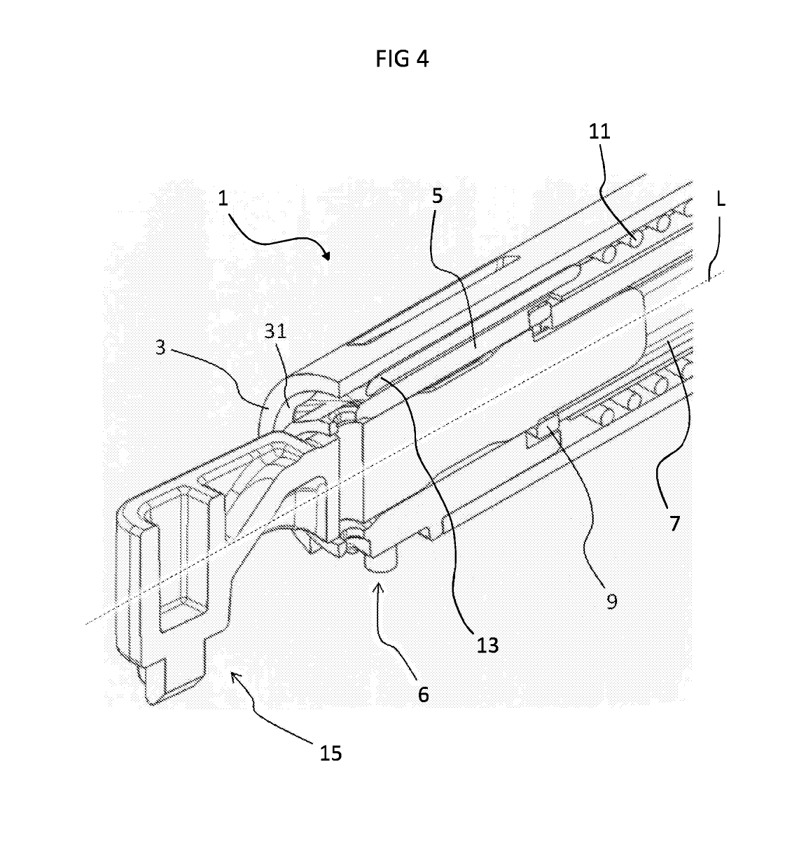

FIG. 4 shows a further exemplary embodiment of an arrangement for a winding system.

Elements of same design and function are labeled with the same reference symbols throughout the figures.

FIG. 1 shows schematically a winding system for a vehicle roof 20 of a motor vehicle in a perspective view. The winding system comprises an arrangement 1, which is suitable for in a simple manner enabling a flexible element to be reliably wound up and/or unwound. For instance, the flexible element is a roller blind and the winding system is a roller blind system, which, as represented in FIG. 1, is arranged in a rear region of the motor vehicle in order to obscure, and open up again, a roof window 21 integrated in the vehicle roof 20. Embodiments of the arrangement 1 which enable the winding system to reliably wind up and/or unwind the roller blind are described in greater detail below on the basis of FIGS. 2 to 4.

FIG. 2 shows in a sectional representation an exemplary embodiment of the arrangement 1 for a winding system, which arrangement comprises a shaft 3 and a bearing bush 5. The bearing bush 5 has a contact surface 52 and a recess 51 and is arranged in a recess 31 of the shaft 3 and is coupled to the shaft 3 by means of a protruding structure 6. The shaft 3 and the bearing bush 5 are configured rotatably about a longitudinal axis L. The arrangement 1 further comprises a bearing element 7, which has a contact surface 72 and which is arranged at a distance from the bearing bush 5 in the recess 31 of the shaft 3. Moreover, the arrangement 1 has sliding element 9, which has a first contact surface 91 and a second contact surface 92 and which is arranged between the bearing bush 5 and the bearing element 7 in the recess 31 of the shaft 3.

The arrangement 1 further comprises a helical spring serving as a drive element 11, which is arranged rotatably about the longitudinal axis L in the recess 31 of the shaft 3 and which at one end is coupled to the bearing bush 5 by means of a spring arm 13. The helical spring 11 is configured such as to wind up and/or unwind a flexible element by means of the bearing bush 5 and the shaft 3, wherein the helical spring 11 exerts a force on the bearing bush 5 in the direction of the bearing element 7, so that the contact surface 52 of the bearing bush 5 and the first contact surface 91 of the sliding element 9, as well as the second contact surface 92 of the sliding element 9 and the contact surface 72 of the bearing element 7, make contact with each other.

In this way, by virtue of the arrangement 1, a winding system which enables the flexible element to be reliably wound up and/or unwound with improved winding behavior is realized, since the interacting components are braced one against another by means of the helical spring 11. Because the helical spring 11 exerts a force on the bearing bush 5 in the direction of the bearing element 7, the bearing bush 5, the sliding element 9 and the bearing element 7 are substantially fixed in their position relative to one another and in relation to the longitudinal axis L. By means of the respective contact surfaces 52 and 91, and 92 and 72, the aforementioned components bear one against the other. Such an abutment of the bearing bush 5 and the sliding element 9 on the one hand, and of the sliding element 9 and the bearing element 7 on the other hand, enables a reliable operation of the arrangement 1 and of the associated winding system, since the position of the interacting components along the longitudinal axis L is substantially maintained. This results, inter alia, in an improved winding behavior of the arrangement 1.

Due to the coupling to the bearing bush 5, the helical spring 11 exerts a tensile force on the bearing bush 5 by means of the spring arm 13. Furthermore, the helical spring 11 acts like a torsion spring and, in interaction with the bearing bush 5 and the shaft 3, enables the flexible element to be wound up and/or unwound. The helical spring 11 thus has a function of a combined tension and torsion spring and holds the bearing bush 5, the sliding element 9 and the bearing element 7 under mechanical tension in a simple manner.

The spring arm 13 extends between the wall of the shaft 3 and the bearing bush 5 and engages at a predefined position in a groove which is configured on an outer contour of the bearing bush 5. Consequently, by means of the helical spring 11, a reliable coupling of the bearing bush 5 to the sliding element 9 and the bearing element 7 is formed. Alternatively or additionally, the bearing bush 5 can have on the outer contour a recess in which the spring arm 13 of the helical spring 11 engages and thus realizes a positive and/or non-positive coupling to the bearing bush 5.

In this way, a displacement of the bearing bush 5 during a rotation of the shaft 3 is prevented, or at least opposed, and so an improved wind-up and/or unwinding of the winding system is realized. Moreover, the described arrangement 1 enables an improved running and an improved smoothness of running of the winding system in comparison to arrangements in which the described components are not braced one against another.

By means of bracing of the respective components, a robust design of the arrangement 1 and a diminished rattling potential of the interacting components during operation of the arrangement 1 is additionally realized. As a result, noise generation is diminished and a worth of the arrangement 1 and of the winding system is increased.

In this exemplary embodiment, the sliding element 9 is of disk-shaped configuration and can also be referred to as a sliding disk. As an additional element between the bearing bush 5 and the bearing element 7, it enables a rotation even in the case of mutually braced components. The sliding element 9 has, for example, material characteristics and a surface properties which in interaction with the helical spring 11 enable, on the one hand, a reliable rotation of the bearing bush 5 and the shaft 3 and, on the other hand, a secure coupling between bearing bush 5 and bearing element 7.

The sliding element 9 is arranged in the recess 51 of the bearing bush 5 and is surrounded by the latter. In this embodiment of the arrangement 1, that part of the wall of the bearing bush 5 which realizes the contact surface 52 to the sliding element 9 is of step-shaped configuration and makes contact with the sliding disk 9 on a circular front side and on the outer wall, which together realize the first contact surface 91 of the sliding disk 9. On a rear side of the sliding element 9, which rear side is facing away from the bearing bush 5, the circular second contact surface 92 makes contact with the substantially likewise circular contact surface 72 of the bearing element 7. In further embodiments of the arrangement 1, the contact surfaces 52, 91, 92 and 72 can respectively also have other geometries.

Moreover, in other embodiments of the arrangement 1, the sliding element 9 can also be arranged outside the recess 51 of the bearing bush 5, or the bearing bush 5 has on a side facing toward the sliding element 9 no recess, so that at least the sliding element 9 is constantly arranged between the bearing bush 5 and the bearing element 7 and a coupling of the bearing bush 5 to the bearing element 7 is realized. An arrangement of the sliding element 9 as a sliding disk within the recess 51 of the bearing bush 5 is, inter alia, advantageous for improved supporting of the bearing bush 5 and of the spring arm 13 of the helical spring 11. The bearing bush 5 is supported against an outer wall of the sliding disk 9 and is thereby stabilized in relation to the longitudinal axis L. Because the sliding disk 9 is arranged within the recess 51 of the bearing bush 5, the bearing bush 5 extends further in the direction of the bearing element 7 and thus additionally enables improved supporting of the spring arm 13.

In the illustrated exemplary embodiment, a rotation of the shaft 3 for the wind-up and/or unwinding of the flexible element is realized by virtue of the fact that the bearing bush 5 is coupled to the shaft 3 by means of the protruding structure 6. The protruding structure is, for instance, a cylindrical elevation, which, radiating from the outer contour of the bearing bush 5, extends through the wall of the shaft 3 in the direction of outside the shaft 3. The wall of the shaft has in this case, for example, at the appropriate position, a recess, which is configured, for instance, congruent to the protruding structure 6 and enables penetration by the protruding structure 6. Alternatively or additionally, other non-positive and/or positive and/or integrally bonded couplings between the bearing bush 5 and the shaft 3 are also possible.

The exemplary embodiment in FIG. 2 additionally shows a bearing journal 15, which extends from outside the shaft 3 through the recess 51 of the bearing bush 5, and through a recess 90 of the sliding disk 9 into a recess 71 of the bearing element 7.

The bearing journal 15 has a pin-shaped structure, which is pressed, for instance, into the recess 71 of the bearing element 7 and realizes a positive and/or non-positive coupling to the bearing element 7. Furthermore, at this position also, further alternative or additional possibilities of the coupling between bearing journal 15 and bearing element 7 exist, so that a reliable and stable winding system is enabled. Moreover, the bearing journal 15 has in the region of the sliding disk 9 a disk-shaped structure, which extends substantially perpendicular to the pin-shaped structure and supports or makes contact with the sliding disk 9 on a side facing toward the bearing bush 5.

In FIGS. 2 and 4, only an arrangement 1 on one side of the winding system is respectively represented. With regard to a symmetrical embodiment of the winding system, at both ends of the shaft 3 are respectively arranged, however, a bearing journal, a bearing bush and a sliding element, which are respectively assigned to one end of the bearing element 7. The helical spring 11 can be configured, for example, as a single helical spring, which at both ends respectively has a spring arm, or there are provided two or more drive elements or helical springs, which realize a reliable coupling of the respective bearing bush to the bearing element 7.

A rotation of the shaft 3 is in this case realized, for example, by virtue of the fact that the helical spring 11 is mounted symmetrically in the middle of the recess 31 of the shaft 3 and imparts a torsional moment or torque to two externally mounted bearing bushes 5 and, due to the coupling by means of two spring arms 13, causes said bearing bushes to rotate. Due to the protruding structure 6 of the respective bearing bushes 5, the shaft too is set in rotation and thus enables the flexible element to be wound up and/or unwound in a reliable and quiet manner.

FIG. 3 shows a further sectional representation of the arrangement 1 represented in FIG. 2 and illustrates a substantially rotationally symmetric structure of the arrangement 1 for a winding system, which structure is beneficial, in particular, with regard to a wind-up and/or unwinding of the flexible element. The shown sectional representation relates to a plane which extends substantially perpendicular to the plane of the sectional representation shown in FIG. 2, at a position of the recess 51 of the bearing bush 5. On the outside is arranged the shaft 3, which circularly surrounds the bearing bush 5, the sliding disk 9 and a part of the bearing journal 15.

FIG. 4 shows a perspective view of the arrangement 1, which represents, for instance, the exemplary embodiment from FIGS. 2 and 3. In this view, inter alia the substantially rotationally symmetric structure of the embodiment of the arrangement 1 is discernible. Furthermore, the helical spring 11 in the form of a combined tension and torsion spring, which has a lengthened spring arm 13 that bears against an outer contour of the bearing bush 5 and engages in an appropriately configured groove, can be seen. In this way, the bearing bush 5 is pulled in the direction of the bearing element and braces the bearing bush 5, the sliding element 9 and the bearing element 7 one against another.

### REFERENCE SYMBOL LIST

1 arrangement

3 shaft

4 shaft wall

5 bearing bush

6 protruding structure, bearing bush

7 bearing element

8 sliding element

11 drive element

13 spring arm

15 bearing journal

20 vehicle roof

21 roof window

23 contact surface, sliding element

31 recess, shaft

51 recess, bearing bush

52 contact surface, bearing bush

71 recess, bearing element

72 contact surface, bearing element

90 recess, sliding element

91 first contact surface, sliding element

92 second contact surface, sliding element

L longitudinal axis

1. An arrangement for a winding system, comprising:
a shaft, which has a recess and a longitudinal axis (L) about which it is rotatably configured,
a bearing bush, which has a contact surface and which is arranged rotatably about the longitudinal axis (L) in the recess of the shaft and is coupled to the shaft,
a bearing element, which has a contact surface and which is arranged at a distance from the bearing bush in the recess of the shaft,
a sliding element, which has a first and a second contact surface and which is arranged between the bearing bush and the bearing element in the recess of the shaft, and
a drive element, which is arranged rotatably about the longitudinal axis (L) in the recess of the shaft and is coupled to the bearing bush and which is configured to wind up and/or unwind the flexible element by means of the shaft, wherein the drive element exerts a force on the bearing bush in the direction of the bearing element, so that the contact surface of the bearing bush and the first contact surface of the sliding element, as well as the contact surface of the bearing element and the second contact surface of the sliding element, make contact with each other.

2. The arrangement as claimed in claim 1, in which the bearing bush has a recess, in which the sliding element is arranged.

3. The arrangement as claimed in claim 1, in which
the drive element is arranged between the bearing element and a wall of the shaft and exerts a tensile force on the bearing bush.

4. The arrangement as claimed in claim 1, in which the drive element has a spring arm, which is coupled to the bearing bush, and by means of the spring arm exerts a tensile force on the bearing bush.

5. The arrangement as claimed in claim 1, in which the sliding element is of a disk-shaped configuration.

6. The arrangement as claimed in claim 1, further comprising:
a bearing journal, which is configured to couple the arrangement to a motor vehicle and which extends from outside the shaft into the recess of the bearing bush and the recess of the shaft.

7. The arrangement as claimed in claim 6, in which
the sliding element has a recess and the bearing element has a recess, and
the bearing journal extends through the recess of the bearing bush and through the recess of the sliding element into the recess of the bearing element and couples to the latter.

8. A winding system for a vehicle roof, comprising
an arrangement as claimed in claim 1, and
the vehicle roof of a motor vehicle.
